(19) United States
(12) Patent Application Publication
(10) Pub. No.: US 2006/0168508 A1
(43) Pub. Date: Jul. 27, 2006

(54) Method and apparatus for preparing source data files

(76) Inventor: Yufeng Zheng, Shanghai (CN)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 11/042,337

(22) Filed: Jan. 26, 2005

(51) Int. Cl. G06F 17/00; G06F 15/00; G06F 17/24; G06F 17/21

(52) U.S. Cl. 715/503; 715/517

(57) ABSTRACT

Methods and systems for preparing source data files by a processing system. The processing system receives, either through an automated process or through manual entry, source data for a source computer system. Next, the processing system compares the value of the dimensions of the source data to the value of the data dimensions of the manipulation program and identifies the source data dimension whose value exceeds the value of the corresponding manipulation program dimension limitation. The processing system reformats the source data so that the exceeded dimension is converted to a second dimension whose value is within the limitation of the corresponding manipulation program dimension. After reformatting the source data, the processing system outputs the reformatted data to the manipulation program.

### TECHNICAL FIELD

This invention relates to the field of enterprise software system integration. More particularly, the present invention relates to methods and systems for preparing and transferring data from legacy systems to enterprise software systems.

### BACKGROUND

Enterprise software systems are integrated software systems that facilitate the flow of information among all the process of an organization's supply chain. With the ever-increasing popularity of enterprise software systems, particularly among companies, firms, and organizations of all sizes, more and more organizations are transitioning from legacy computing systems to new enterprise software systems. As a result, organizations require efficient and straightforward ways to prepare and transfer data from the legacy computing systems to the enterprise software systems.

Legacy System Migration Workbench (“LSMW”) of SAP© AG serves as an illustrative example of a tool that prepares and transfers data from legacy computing systems to an enterprise software system such as the SAP R/3™ system (“SAP R/3”). The SAP R/3 architecture comprises application and database servers. The application servers host application software modules, which share data through the SAP R/3 databases stored in the database servers.

Existing commercially available software may be used as intermediate software, to facilitate this process. For example, a spreadsheet, such as Microsoft Excel, may be used. However, when creating and exporting data records to the enterprise system, using existing software, difficulty may arise if records to be imported by the LSMW are arranged such that a dimension of such records exceeds a limitation imposed by the intermediate software, rendering the intermediate software incompatible with the data records to be imported.

Accordingly, there is a need for systems and methods overcome limitations intermediate software to facilitate the preparation and transfer of data from legacy systems to enterprise software systems.

### SUMMARY

Consistent with the principles of the present invention, a method is provided for processing source data generated by a source computer system to form reformatted data compatible with a data manipulation program, the manipulation program having a plurality of data dimensions, at least a first dimension having a limitation, the source computer data having dimensions corresponding to the dimensions of the manipulation program, the source computer system data dimension corresponding to the first dimension having a value exceeding the limitation. The method comprises receiving the source data; comparing the value of the dimensions of the source data to the values of limitations of corresponding data dimensions of the manipulation program; identifying a source data dimension whose value exceeds the value of the limitation of the corresponding manipulation program dimension limitation; reformatting the source data such that the exceeded dimension is converted to a second dimension whose value is within the limitation of the corresponding manipulation program dimension; and outputting the reformatted data to the manipulation program.

Consistent with another embodiment of the present invention, an apparatus is provided for processing source data generated by a source computer system to form reformatted data compatible with a data manipulation program, the manipulation program having a plurality of data dimensions, at least a first dimension having a limitation, the source computer data having dimensions corresponding to the dimensions of the manipulation program, the source computer system data dimension corresponding to the first dimension having a value exceeding the limitation. The apparatus comprises an input component for receiving the source data and a processor including a reformatting module, the reformatting module compares the value of the dimensions of the source data to the values of limitations of corresponding data dimensions of the manipulation program, identifies a source data dimension whose value exceeds the value of the limitation of the corresponding manipulation program dimension limitation, reformats the source data such that the exceeded dimension is converted to a second dimension whose value is within the limitation of the corresponding manipulation program dimension; and outputs the reformatted data to the manipulation program.

Consistent with another embodiment of the present invention, a computer-readable medium is provided containing instructions for performing a method for processing source data generated by a source computer system to form reformatted data compatible with a data manipulation program, the manipulation program having a plurality of data dimensions, at least a first dimension having a limitation, the source computer data having dimensions corresponding to the dimensions of the manipulation program, the source computer system data dimension corresponding to the first dimension having a value exceeding the limitation. The method comprises receiving the source data; comparing the value of the dimensions of the source data to the values of limitations of corresponding data dimensions of the manipulation program; identifying a source data dimension whose value exceeds the value of the limitation of the corresponding manipulation program dimension limitation; reformatting the source data such that the exceeded dimension is converted to a second dimension whose value is within the limitation of the corresponding manipulation program dimension; and outputting the reformatted data to the manipulation program.

### BRIEF DESCRIPTION OF THE DRAWINGS

Both the foregoing general description and the following detailed description are exemplary and explanatory only. They do not restrict the invention, as claimed. Furthermore, the accompanying drawings, which are incorporated in and constitute a part of this specification, illustrate one (or several) embodiments of the invention and together with the description, serve to explain the principles of the invention. In the drawings:

FIG. 1 is a block diagram of an exemplary system for preparing and transferring data from legacy computing systems to enterprise software systems consistent with the principles of the present invention;

FIG. 2 is a flow diagram for preparing and transferring data from legacy computing systems to enterprise software systems, consistent with the principles of the present invention; and

FIG. 3 is an exemplary graphical user interface of the process for preparing and transferring data from legacy computing systems to enterprise software systems, consistent with the principles of the present invention.

### DETAILED DESCRIPTION

Methods and systems consistent with the present invention provide a mechanism for preparing and transferring data from a legacy system to an enterprise software system. The mechanism receives, either through an automated process or through manual entry, source data formatted in multiple dimensions. For example, the data may be formatted into two dimensions as a series of records, with each record having a plurality of fields. Next, the mechanism compares the value of the dimensions of the source data to the value of the data dimensions of a manipulation program and the mechanism identifies any source data dimension whose value exceeds the value of a limitation of a corresponding manipulation program dimension. The mechanism reformats the source data so that the exceeded dimension is converted to a second dimension whose value is within the limitation of the corresponding manipulation program dimension. After reformatting the source data, the mechanism outputs the reformatted data to the manipulation program.

Reference will now be made in detail to present embodiments of the invention, examples of which are illustrated in the accompanying drawings. Wherever possible, the same reference numbers will be used throughout the drawings to refer to the same or like parts.

System Configuration

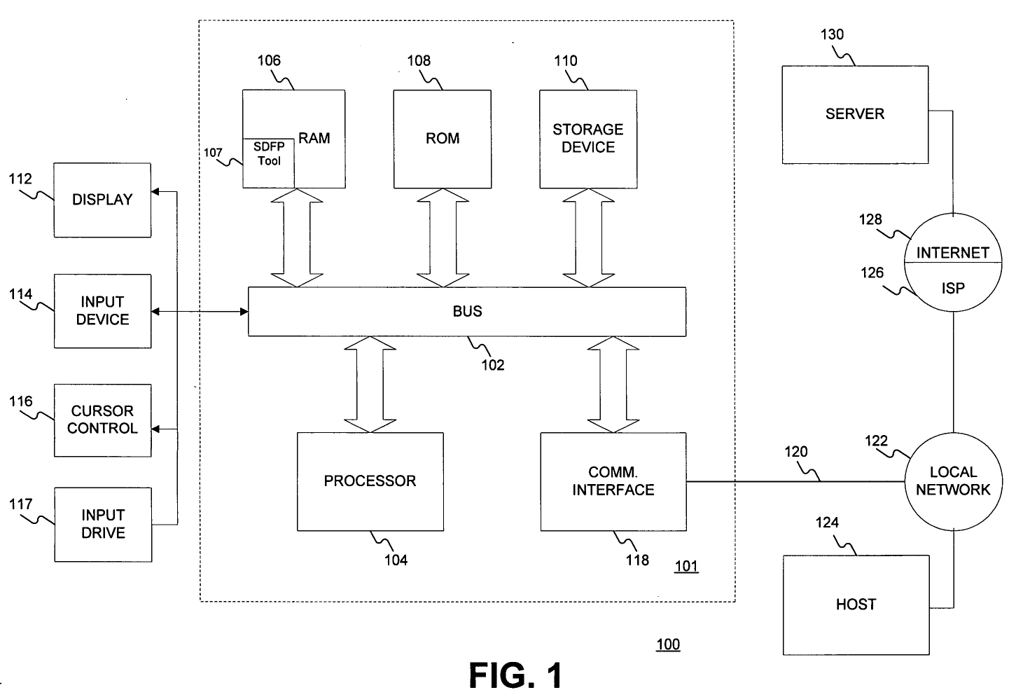

Systems and methods consistent with the present invention may be implemented by computers organized in a conventional distributed processing system architecture. FIG. 1 is a block diagram illustrating a computer system 100 in which an embodiment consistent with the invention may be implemented. Computer system 100 includes a computer 101 having a bus 102 or other communication mechanism for communicating information, and a processor 104 coupled with bus 102 for processing information. Computer 101 also includes a main memory, such as random access memory (RAM) 106 or other dynamic storage device, coupled to bus 102 for storing information and instructions to be executed by processor 104. RAM 106 also may be used for storing temporary variables or other intermediate information during execution of instructions to be executed by processor 104. Computer 101 may further include a read only memory (ROM) 108 or other static storage device coupled to bus 102 for storing static information and instructions for processor 104. A storage device 110, such as a magnetic disk or optical disk, may be provided and coupled to bus 102 for storing information and instructions.

Computer 101 may be coupled via bus 102 to a display 112, such as a cathode ray tube (CRT), for displaying information to a computer user. An input device 114, such as a keyboard including alphanumeric and other keys, is coupled to bus 102 for communicating information and command selections to processor 104. Another type of user input device is cursor control 116, such as a mouse, a trackball or cursor direction keys for communicating direction information and command selections to processor 104 and for controlling cursor movement on display 112. This input device typically has two degrees of freedom in two axes, a first axis (e.g., x) and a second axis (e.g., y), which allow the device to specify positions in a plane. System 100 may further include an input drive device 117, such as a CD reader, for reading high-capacity computer-readable media, such as CD-ROMs and CDRs.

According to one implementation, systems and methods consistent with the present invention import and prepare source data from legacy systems for transfer to enterprise software systems when processor 104 executes one or more sequences of instructions, such as a source data file preparation tool 107, contained in RAM 106. Such instructions may be read into RAM 106 from a computer-readable medium via an input device such as storage device 110. Execution of the sequences of instructions contained in main memory 106 causes processor 104 to perform the process steps described herein. In an alternative implementation, hard-wired circuitry may be used in place of or in combination with software instructions to implement the invention. Thus, implementations consistent with the principles of the present invention are not limited to any specific combination of hardware circuitry and software.

The term “computer-readable medium” as used herein refers to any media that participates in providing instructions to processor 104 for execution. Such a medium may take many forms, including but not limited to, non-volatile media, volatile media, and transmission media. Non-volatile media includes, for example, optical or magnetic disks, such as storage device 110. Volatile media includes dynamic memory, such as main memory 106. Transmission media includes coaxial cables, copper wire and fiber optics, including the wires that comprise bus 102. Transmission media can also take the form of acoustic or light waves, such as those generated during radio-wave and infra-red data communications. Common forms of computer-readable media include, for example, a floppy disk, a flexible disk, hard disk, magnetic tape, or any other magnetic medium, a CD-ROM, any other optical medium, punch cards, paper tape, any other physical medium with patterns of holes, a RAM, PROM, and EPROM, a FLASH-EPROM, any other memory chip or cartridge, a carrier wave as described hereinafter, or any other medium from which a computer can read.

Various forms of computer-readable media may be involved in carrying one or more sequences of instructions to processor 104 for execution. For example, the instructions may initially be carried on the magnetic disk of a remote computer. The remote computer can load the instructions into its dynamic memory and send the instructions over a telephone line using a modem. A modem (not shown) local to computer system 100 can receive the data on the telephone line and supply the data to computer 101 via a communications interface 118, which places the data on bus 102. Bus 102 carries the data to main memory 106, from which processor 104 retrieves and executes the instructions. The instructions received by main memory 106 may optionally be stored on storage device 110 either before or after execution by processor 104.

Communication interface 118 may also provide a two-way data communication coupling to a network link 120 that may be connected to a local network 122. For example, communication interface 118 may support an integrated services digital network (ISDN) card or a modem to provide a data communication connection to a corresponding type of telephone line. As another example, communication interface 118 may be a local area network (LAN) card to provide a data communication connection to a compatible LAN. Wireless links may also be implemented. In any such implementation, communication interface 118 sends and receives electrical, electromagnetic or optical signals that carry digital data streams representing various types of information.

Network link 120 typically provides data communication through one or more networks to other data devices. For example, network link 120 may provide a connection through local network 122 to a host computer 124 and/or to data equipment operated by an Internet Service Provider (ISP) 126. ISP 126, in turn, provides data communication services through the Internet 128. Local network 122 and Internet 128 both use electric, electromagnetic, or optical signals to carry digital data streams. The signals through the various networks and the signals on network link 120 and through communication interface 118, which carry the digital data to and from computer system 100, are exemplary forms of carrier waves transporting the information.

Computer system 100 can send messages and receive data, including program code, through the network(s), network link 120, and communication interface 118. In the Internet example, a server 130 might transmit requested program instructions for an application program through Internet 128, ISP 126, local network 122, and communication interface 118. Consistent with the present invention, one such downloaded application in the form of a source data file preparation tool 107 comprises a reformatting module which prepares the source data file on a computer system. In one embodiment, a macro, a script, or a program code is designed to execute in a manipulation module. The manipulation module, which may be a spreadsheet (e.g. Microsoft Excel), operates as the source data file preparation tool 107. The received application code may be loaded in RAM 106 and executed by processor 104 as it is received. Alternatively, or in addition, it may be stored in storage device 110, or other non-volatile storage for later execution. In this manner, computer system 100 may obtain application code in the form of a carrier wave.

Although computer system 100 is shown in FIG. 1 as being connectable to one server 130, those skilled in the art will recognize that computer system 100 may establish connections to multiple servers on Internet 128. Such servers may include an HTML-based Internet application, which may provide information to computer system 100 upon request in a manner consistent with the present invention.

System Operation for Preparing Source Data Files

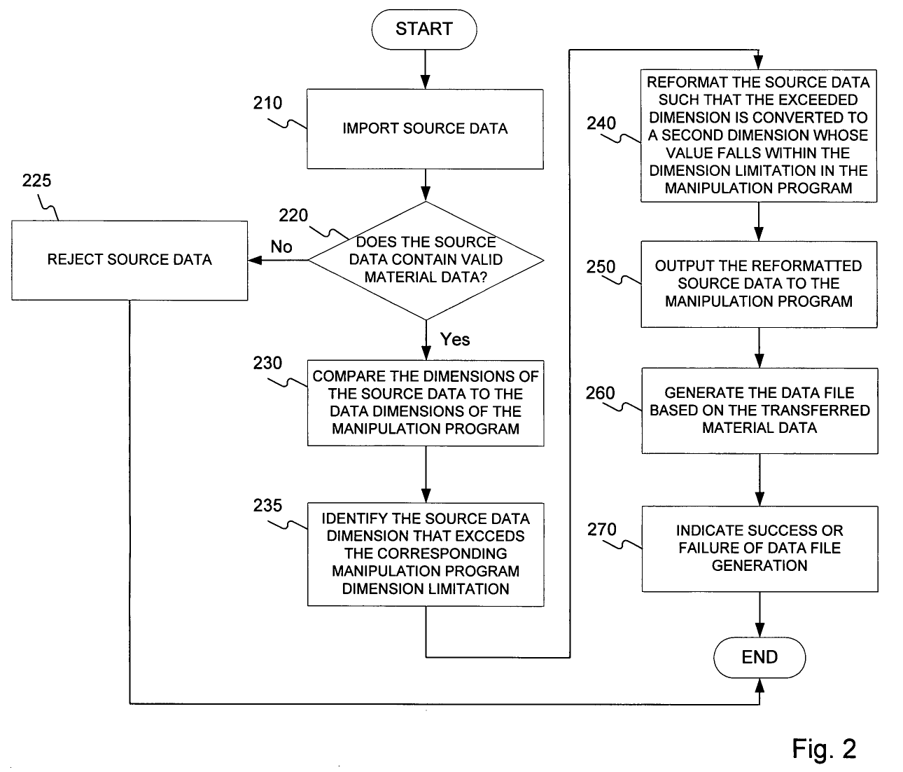

FIG. 2 is a flow diagram of a process, consistent with the invention, for preparing and transferring data from a legacy computing system to an enterprise software system. The process may be used, for example, to transfer material data using manipulation software.

At the start of the process as indicated in stage 210, a processor (e.g. FIG. 1, element 104) executes instructions for preparing source data files and receiving source data from a legacy computing system. This may occur, for example, automatically at a specified time or event, such as when the computer system receives via input drive (e.g. FIG. 1 element 117) or a network (e.g. FIG. 1 elements 122, 126, and 128) source data from a host or server (e.g. FIG. 1 element 124 and 130), the host or server operating as part of a legacy computing system. The computer system may also execute instructions for preparing source data files through a manual process, for example, when a user manually initiates the execution of the instructions for preparing source data files, and enters or edits the source data in the computer system. In one embodiment, the user may enter or edit the source data using a manipulation program, such as a spreadsheet (e.g. Microsoft Excel).

Next, in stage 220, the computer system verifies that the source data entered or edited in stage 210 contains valid data. Data verification is well-known in the art and does not warrant further discussion. If the computer system determines that the source data entered or edited in stage 210 does not contain valid data, then the process enters stage 225, rejects the source data, and terminates. Alternatively, if the computer system determines that the source data entered or edited in stage 210 does contain valid data, then the process proceeds to stage 230.

In stage 230, the computer system compares the value of the dimensions of the source data to the limitation of a manipulation program, such as a spreadsheet (e.g. Microsoft Excel), in terms of data dimensions. For example, the source data may contain material master data records for twenty materials having 500 characteristics. This data is formatted in the form of records, with one record for each material and one field for each characteristic. In the legacy system, the data is represented in the form of rows and columns, with one record forming one row and each of the 500 characteristics appearing as a separate column. Material master data records contain all the basic information required to manage a material. A “material” may be a substance used, consumed, or generated during production, such as a chemical element or compound. A “material” may also be an object dealt with on a commercial basis, such as an automobile or an airplane. As another example, a “material” may be goods that are the subject of business activity, such as items that can be traded, used in manufacture, consumed, or produced. A service may also be treated as a material.

The data contained in material master data is sorted according to various criteria including data of a descriptive nature (e.g. size, dimension, and weight) and data with a control function (e.g. material type and industry sector). In addition to the above listed data stored in the data records, which can be directly maintained by the user, the data records also contains data that is automatically updated by the system (e.g. inventory levels).

Next, in stage 235, the computer system determines whether any dimension of the source data has a value exceeding the value of a limitation of the corresponding dimension in the manipulation programs. Using the above example, in which the manipulation program is Microsoft Excel, we note that the twenty rows, each representing a material data record, do not exceed any limitation for rows in Excel. In fact, the limitation for the new dimension in Excel is infinite. However, the limitation for the column dimension of Excel is 255. Thus, the column dimension of the source data (500) exceeds the limitation of the corresponding column dimension in Excel.

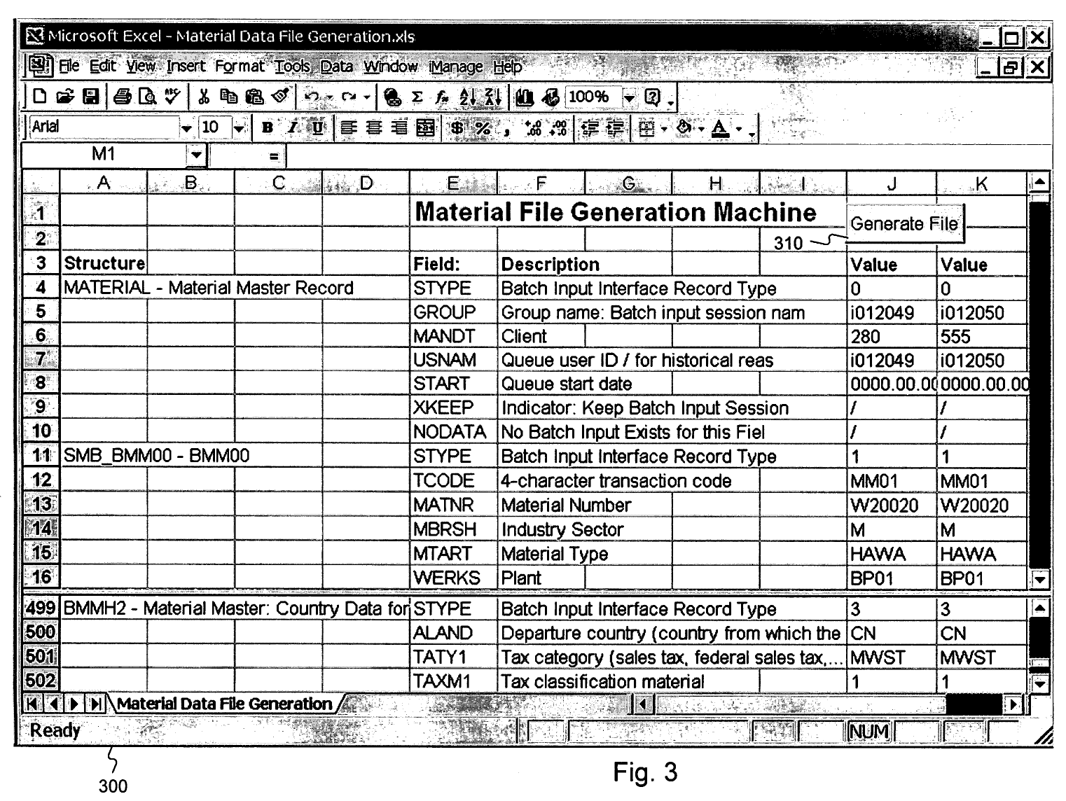

Based on the determination made in stage 235, the computer system in stage 240 reformats the source data such that the exceeded dimension is converted to another dimension whose value is within the dimension limitation of the manipulation program. Continuing with the example in which the source data contains data for 20 materials normally stored in rows, each having 500 data fields normally stored in columns, the computer system in stage 240 reformats the source data such that the records are stored in columns and each of the 500 characteristic data fields are stored as rows. As a result of the reformat, storing 500 data fields no longer exceeds the dimension limitation of the manipulation program. Then in stage 250, the computer system outputs the reformatted source data to the manipulation program. An exemplary embodiment of the result of the process at stage 250 is shown as element 300 of FIG. 3. In the event that the number of records exceeds the column limitation (255), then the records can be processed as batches, with each batch created to have fewer than 255 records.

In stage 260, the computer system receives a command to generate a data file from the material data outputted in stage 250. The command may be issued manually, for example, by the user who manually commands the computer system to generate the data file. In an embodiment as shown in FIG. 3, the user clicks on a command button (e.g. FIG. 3 element 310) in a spreadsheet to manually command the computer system to generate the data file. Alternatively, the command may be issued automatically at a specified time or event, such as the completion of material data output in stage 250. The computer system generates the data file from the transferred material data. The computer system retrieves the material data in the data column and generates the data file in a format and structure that satisfies the requirements of the enterprise software system. Then, in stage 270, the computer system indicates whether the data file generation in stage 260 succeeded or failed.

The foregoing descriptions of the invention have been presented for purposes of illustration and description. They are not exhaustive and do not limit the invention to the precise form disclosed. Modifications and variations are possible in light of the above teachings or may be acquired from practicing of the invention. For example, the described implementation includes software but the present invention may be implemented as a combination of hardware and software or in hardware alone. Additionally, although aspects of the present invention are described as being stored in memory, one skilled in the art will appreciate that these aspects can also be stored on other types of computer-readable media, such as secondary storage devices, like hard disks, floppy disks, or CD-ROM; a carrier wave from the Internet or other propagation medium; or other forms of RAM or ROM. The scope of the invention is defined by the claims and their equivalents.

Other embodiments of the invention will be apparent to those skilled in the art from consideration of the specification and practice of the invention disclosed herein. The specification and examples should be considered as exemplary only, with a true scope and spirit of the invention being indicated by the following claims.

What is claimed is:

1. A method for processing source data generated by a source computer system to form reformatted data compatible with a data manipulation program, the manipulation program having a plurality of data dimensions, at least a first dimension having a limitation, the source computer data having dimensions corresponding to the dimensions of the manipulation program, the source computer system data dimension corresponding to the first dimension having a value exceeding the limitation, comprising:
receiving the source data;
comparing the value of the dimensions of the source data to the values of limitations of corresponding data dimensions of the manipulation program;
identifying a source data dimension whose value exceeds the value of the limitation of the corresponding manipulation program dimension limitation;
reformatting the source data such that the exceeded dimension is converted to a second dimension whose value is within the limitation of the corresponding manipulation program dimension; and
outputting the reformatted data to the manipulation program.

2. The method of claim 1, wherein the manipulation program comprises a spreadsheet.

3. The method of claim 2, wherein the spreadsheet contains a row dimension and a column dimension.

4. The method of claim 3, wherein the column dimension has a limitation.

5. The method of claim 4, wherein the value of the column dimension in the source data exceeds the limitation.

6. The method of claim 5, wherein reformatting further comprises:
reformatting the source data such that a row of source data is converted into a column in the manipulation program.

7. The method of claim 6, wherein receiving further comprises:
receiving the source data through an automated process.

8. The method of claim 6, wherein receiving further comprises:
receiving the source data through a manual process.

9. A method for processing source data generated by a source computer system to form reformatted data compatible with a spreadsheet manipulation program, the manipulation program having first and second dimensions, the first dimension having a limitation, the source data having dimensions corresponding to the dimensions of the manipulation program and having values, the source data dimension corresponding to the first dimension exceeding the limitation, the method comprising:
receiving the source data;
identifying the source data dimension corresponding to the first dimension;
reformatting the source data such that the source data dimension corresponding to the first dimension is converted to a dimension whose value does not exceed the limitation; and
outputting the reformatted data to the manipulation program.

10. A method for processing source data generated by a source computer system to form reformatted data compatible with a spreadsheet manipulation program, the manipulation program having first and second dimensions, the first dimension having a limitation, the source data having dimensions corresponding to the dimensions of the manipulation program and having values, the method comprising:
receiving the source data;
comparing the value of the source data dimension corresponding to the first dimension to the limitation;
if the value of the source data dimension corresponding to the first dimension exceeds the limitation, reformatting the source data such that the dimension whose value exceeds the limitation is converted to a dimension whose value does not exceed the limitation; and
outputting the reformatted data to the manipulation program.

11. An apparatus for processing source data generated by a source computer system to form reformatted data compatible with a data manipulation program, the manipulation program having a plurality of data dimensions, at least a first dimension having a limitation, the source computer data having dimensions corresponding to the dimensions of the manipulation program, the source computer system data dimension corresponding to the first dimension having a value exceeding the limitation, comprising:
an input component for receiving the source data; and
a processor including a reformatting module, the reformatting module compares the value of the dimensions of the source data to the values of limitations of corresponding data dimensions of the manipulation program, identifies a source data dimension whose value exceeds the value of the limitation of the corresponding manipulation program dimension limitation, reformats the source data such that the exceeded dimension is converted to a second dimension whose value is within the limitation of the corresponding manipulation program dimension; and outputs the reformatted data to the manipulation program.

12. The apparatus of claim 11, wherein the manipulation program comprises a spreadsheet.

13. The apparatus of claim 12, wherein the spreadsheet contains a row dimension and a column dimension.

14. The apparatus of claim 13, wherein the column dimension has a limitation.

15. The apparatus of claim 14, wherein the value of the column dimension in the source data exceeds the limitation.

16. The apparatus of claim 15, wherein reformatting module reformats the source data such that a row of source data is converted into a column in the manipulation program.

17. The apparatus of claim 16, wherein reformatting module receives the source data through an automated process.

18. The apparatus of claim 16, wherein reformatting module receives the source data through a manual process.

19. A computer-readable medium including instructions, executable by a processor, for performing a method for processing source data generated by a source computer system to form reformatted data compatible with a data manipulation program, the manipulation program having a plurality of data dimensions, at least a first dimension having a limitation, the source computer data having dimensions corresponding to the dimensions of the manipulation program, the source computer system data dimension corresponding to the first dimension having a value exceeding the limitation, comprising:
receiving the source data;
comparing the value of the dimensions of the source data to the values of limitations of corresponding data dimensions of the manipulation program;
identifying a source data dimension whose value exceeds the value of the limitation of the corresponding manipulation program dimension limitation;
reformatting the source data such that the exceeded dimension is converted to a second dimension whose value is within the limitation of the corresponding manipulation program dimension; and
outputting the reformatted data to the manipulation program.

20. The computer-readable medium of claim 19, wherein the manipulation program comprises a spreadsheet.

21. The computer-readable medium of claim 20, wherein the spreadsheet contains a row dimension and a column dimension.

22. The computer-readable medium of claim 21, wherein the column dimension has a limitation.

23. The computer-readable medium of claim 22, wherein the value of the column dimension in the source data exceeds the limitation.

24. The computer-readable medium of claim 23, wherein reformatting further comprises:
reformatting the source data such that a row of source data is converted into a column in the manipulation program.

25. The computer-readable medium of claim 24, wherein receiving further comprises:
receiving the source data through an automated process.

26. The computer-readable medium of claim 24, wherein receiving further comprises:
receiving the source data through a manual process.

27. A system for processing source data generated by a source computer system to form reformatted data compatible with a data manipulation program, the manipulation program having a plurality of data dimensions, at least a first dimension having a limitation, the source computer data having dimensions corresponding to the dimensions of the manipulation program, the source computer system data dimension corresponding to the first dimension having a value exceeding the limitation, comprising:
means for receiving the source data;
means for comparing the value of the dimensions of the source data to the values of limitations of corresponding data dimensions of the manipulation program;
means for identifying a source data dimension whose value exceeds the value of the limitation of the corresponding manipulation program dimension limitation;
means for reformatting the source data such that the exceeded dimension is converted to a second dimension whose value is within the limitation of the corresponding manipulation program dimension; and
means for outputting the reformatted data to the manipulation program.

28. The system of claim 27, wherein the manipulation program comprises a spreadsheet.

29. The system of claim 28, wherein the spreadsheet contains a row dimension and a column dimension.

30. The system of claim 29, wherein the column dimension has a limitation.

31. The system of claim 30, wherein the value of the column dimension in the source data exceeds the limitation.

32. The system of claim 31, wherein the means for reformatting further comprises:
means for reformatting the source data such that a row of source data is converted into a column in the manipulation program.

33. The system of claim 32, wherein the means for receiving further comprises:
means for receiving the source data through an automated process.

34. The system of claim 32, wherein the means for receiving further comprises:
means for receiving the source data through a manual process.
